(19) United States
(12) Patent Application Publication
(10) Pub. No.: US 2026/0142218 A1
(43) Pub. Date: May 21, 2026

(54) SYSTEMS AND METHODS FOR PERFORATED JELLYROLL BATTERY

(71) Applicant: Ford Global Technologies, LLC, Dearborn, MI (US)

(72) Inventors: Myoungshin Hong, Ann Arbor, MI (US); Yooseong Lee, Novi, MI (US); Daewon Han, New Hudson, MI (US); Chi Paik, Grosse Ile, MI (US); Kent Snyder, Dearborn, MI (US)

(21) Appl. No.: 18/952,585

(22) Filed: Nov. 19, 2024

(51) Int. Cl. H01M 10/04; H01M 4/70; H01M 50/103; H01M 50/55

(52) U.S. Cl. CPC H01M 10/0431; H01M 4/70; H01M 50/103; H01M 50/55

(57) ABSTRACT

Methods and systems are provided for a perforated jellyroll battery. In one example, the perforated jellyroll battery may include a perforated anode including an anode active material layer, an anode current collector and anode perforations, a perforated cathode including a cathode active material layer, a cathode current collector and cathode perforations, and a separator positioned between the perforated anode and the perforated cathode. The anode perforations are axially and radially aligned with the cathode perforations, with respect to the jellyroll battery.

### FIELD

The present description relates generally to systems and methods for a perforated jellyroll battery.

### BACKGROUND/SUMMARY

Battery powered systems may have a battery pack comprising a plurality of battery cells coupled in series and in parallel. Alternatively, a single large format battery cell configured to output the demanded current and voltage may be used. Large format battery cells may be configured in a stacked architecture instead of a jellyroll (e.g., wound) architecture due to a cell size of jellyroll batteries being limited by ability of electrolyte to penetrate to an axial center of the jellyroll battery when cell size is increased. However, jellyroll architecture may be selected over stacked architecture due to winding being a faster manufacturing process than stacking and the jellyroll architecture providing a direction to vent evolved gases.

Attempts to address efficient electrolyte distribution have included adding cuts or perforations to a separator of the battery cell or to either axial end of a jellyroll battery.

In one example, a perforated jellyroll battery, comprising a perforated anode including an anode active material layer, an anode current collector and anode perforations passing vertically with respect to an axis of an unwound perforated anode through the anode active material layer and the anode current collector; a perforated cathode including a cathode active material layer, a cathode current collector and cathode perforations passing vertically with respect to an axis of the unwound perforated cathode through the cathode active material layer and cathode current collector, and a separator positioned between the perforated anode and perforated cathode, and wherein with respect to an axis of the perforated jellyroll battery, the anode perforations are radially and axially aligned with the cathode perforations. In this way, an axial length of a battery in a jellyroll architecture may not be limited by axial distribution of electrolyte. By increasing an axial length, an energy storage capacity of a single jellyroll battery cell may be increased.

As one example, the cathode perforations are mirror images of the anode perforations and both the anode and cathode and include a plurality of perforations which are laterally offset from each other. In this way, a path for radial penetration of electrolyte throughout the active material of the electrodes is sufficiently provided. Further, the lateral offset may mitigate localized heating caused by interrupting current flow through the current collectors.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows an illustration of a battery system including a prismatic battery housing and a jellyroll battery.

FIG. 2 shows an illustration of jellyroll battery of the prior art in conventional and large formats.

FIG. 3 shows an illustration of a first example of a perforated jellyroll battery.

FIG. 4 shows an illustration of a second example of the perforated jellyroll battery.

FIG. 5 shows an illustration of a third example of the perforated jellyroll battery.

FIG. 6 shows an illustration of a fourth example of the perforated jellyroll battery.

FIG. 7 shows an illustration of a fifth example of the perforated jellyroll battery.

FIG. 8 shows a flowchart of an example of a method for forming the perforated jellyroll battery.

FIG. 9 shows an illustration of a roll-to-roll manufacturing process for forming the jellyroll battery.

FIG. 10 shows a cross section of a perforated anode stacked on a perforated cathode for forming the perforated jellyroll battery.

### DETAILED DESCRIPTION

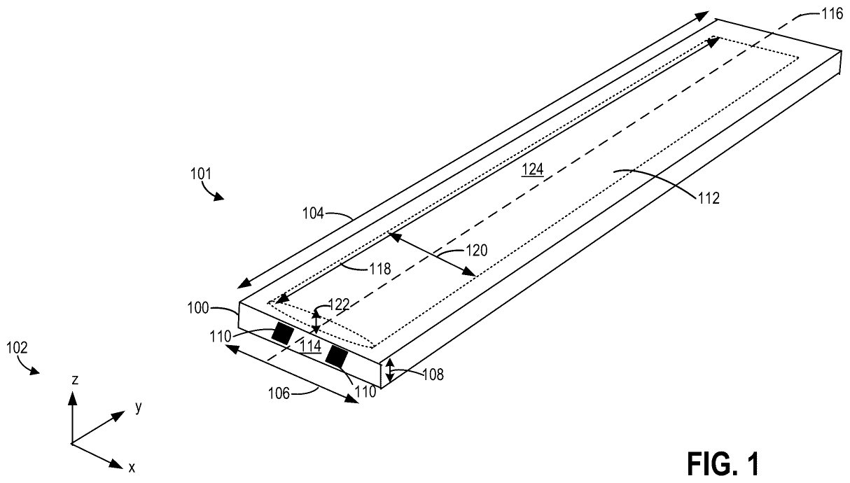

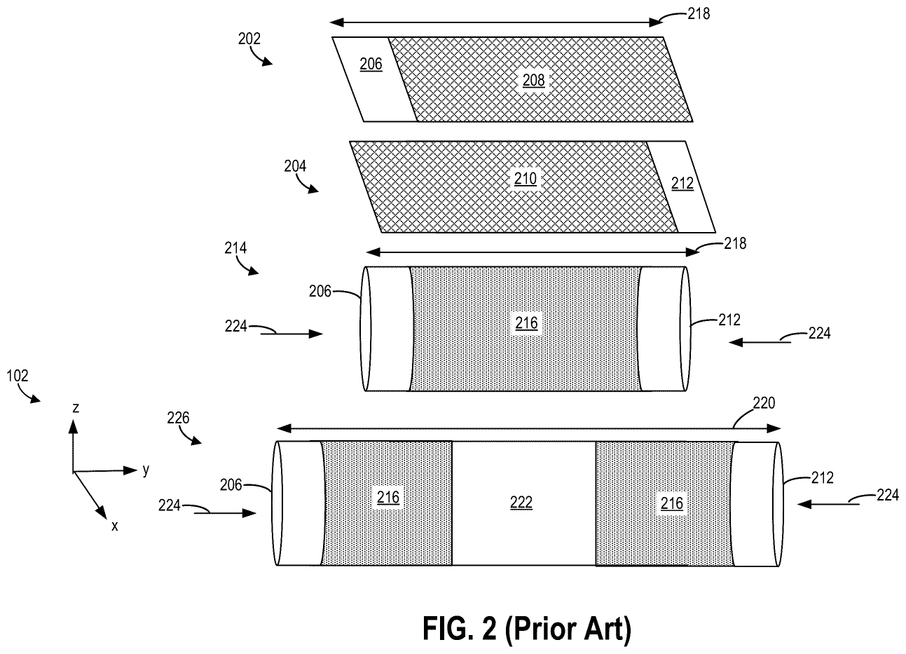

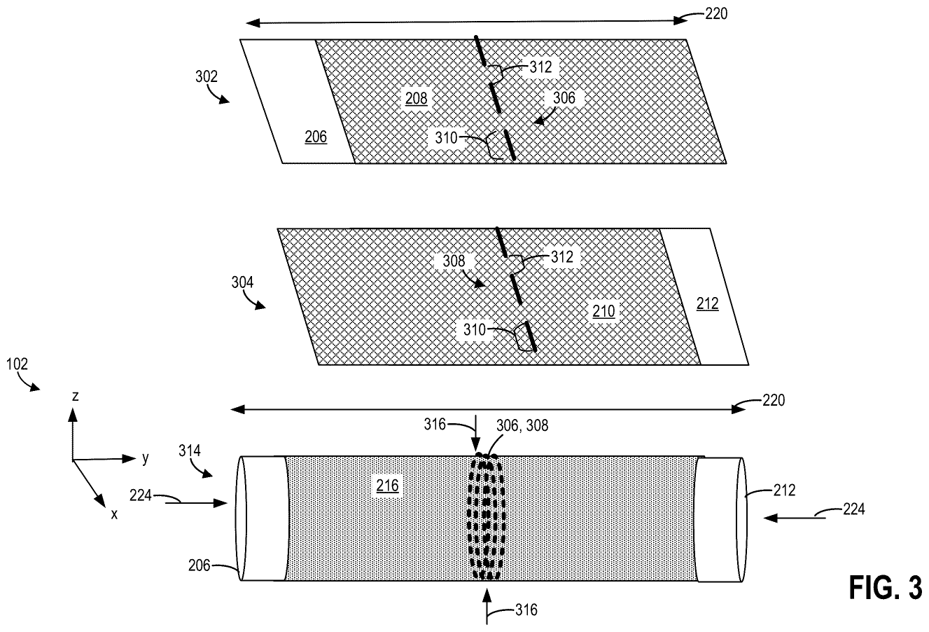

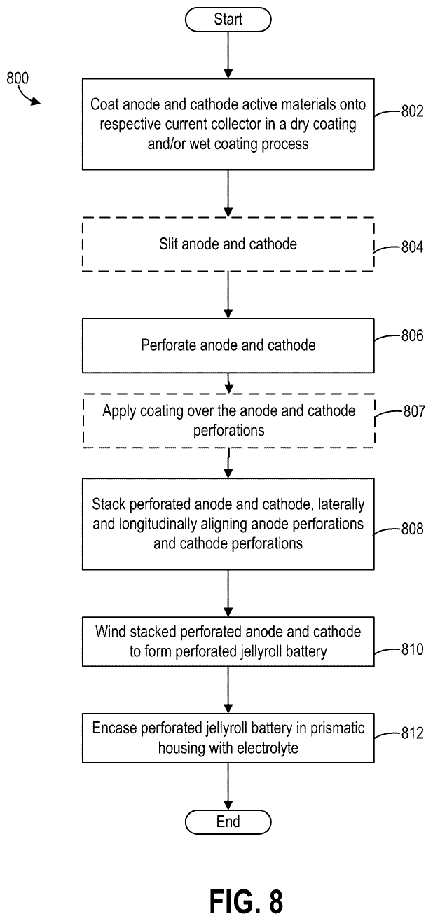

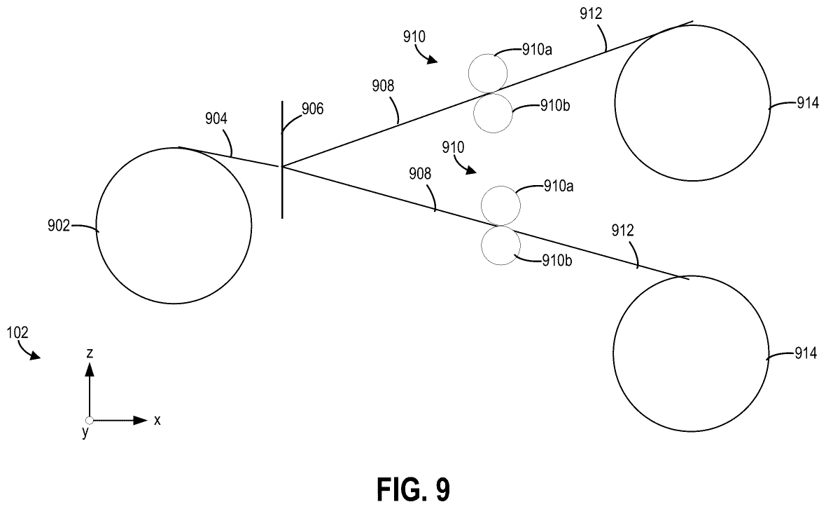

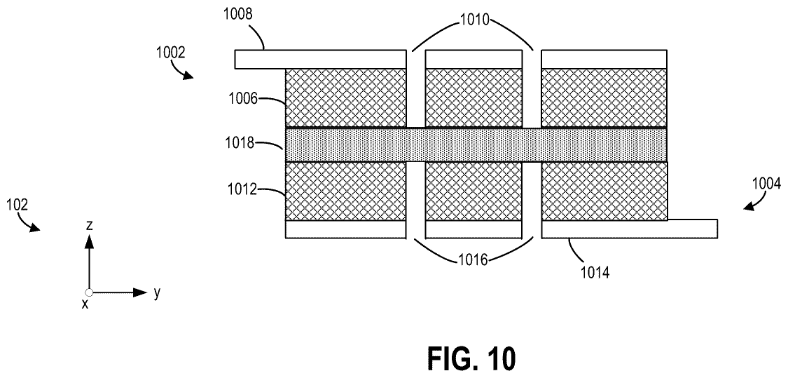

The following description relates to systems and methods for a perforated jellyroll battery architecture. Due to the perforations, the jellyroll battery may be a large format jellyroll battery. A single large format jellyroll battery architecture may be included in a prismatic battery housing, such as the housing shown in FIG. 1. Including a single large format jellyroll battery in prismatic battery housing may be preferred over multiple conventionally sized jellyroll batteries. A large format jellyroll battery may be axially longer than a conventional jellyroll battery. In the prior art, increasing an axial length of the jellyroll battery may result in portions of the battery which are not wet by electrolyte as illustrated in FIG. 2. By providing perforations in the current collector and electrode of both the anode and cathode, radial paths for permeation of electrolyte to the jellyroll battery may be introduced, thereby enabling a large format jellyroll battery, such as a jellyroll battery which may be included in prismatic battery housing of FIG. 1. FIGS. 3-7 show examples of perforated electrodes and the resulting perforated jellyroll battery. A flowchart of an example of a method for forming the perforated jellyroll batteries shown in FIGS. 3-7 is shown in FIG. 8. The perforated jellyroll battery may be manufactured via a roll-to-roll process as illustrated in FIG. 9. An illustration in FIG. 10 shows an example of a perforated cathode stacked on a perforated anode as part of the manufacturing process described in FIG. 8.

Turning now to FIG. 1, it shows a battery system 101 including a prismatic battery housing 100. A reference axis 102 is provided including an x axis, y axis and z axis to compare the illustrations of FIGS. 1-7 and 9-10. The y axis may be a parallel to a longitudinal direction with respect to the battery housing and unwound battery electrodes (e.g., anode and cathode) and may be parallel to an axial direction of the jellyroll battery. The x axis may be parallel to a lateral direction with respect to the battery housing and unwound battery electrodes and may be parallel to a radial direction of the jellyroll battery. The z axis may be parallel to a vertical direction with respect to the battery housing and battery electrode and may also be parallel to the radial direction of the jellyroll battery.

Prismatic battery housing 100 may be shaped as a rectangular prism having a longitudinal length 104, a lateral length 106 and height 108. Lateral length 106 may be shorter than longitudinal length 104 and a height 108 may be shorter than both longitudinal length 104 and lateral length 106. In one example, longitudinal length 104 may be ≥300 mm, lateral length 106 may be in a range from 9 mm to 120 mm, and height 108 may be in range from 15 mm to 30 mm. As a further example, longitudinal length 104 may be 590 mm, lateral length 106 may be 105 mm and height 108 may be 15.5 mm. Prismatic battery housing may include terminals 110 configured to electrically couple prismatic battery housing 100 to a load. In one example the load may be a vehicle including an electric machine powered by a jellyroll battery 112 positioned within prismatic battery housing 100. Terminals 110 may be positioned on a lateral side face 114 of prismatic battery housing 100. Lateral side face 114 may be the smallest face of prismatic battery housing 100.

Jellyroll battery 112 may be a single battery cell positioned within prismatic battery housing 100. Jellyroll battery 112 may be formed of an anode, separator, cathode stacked vertically and spirally wound around axis 116. An outer surface 124 jellyroll battery 112 may be a current collector of the anode or cathode. A radial cross section of jellyroll battery 112 may include repeating sequential layers of cathode current collector, cathode active material, separator, anode active material, and anode current collector. Current collectors may be formed of metal foil.

Jellyroll battery 112 may be shaped as an elliptical cylinder. Jellyroll battery 112 may be an axial length 118, a long axis of the elliptical cross section may be parallel to the lateral direction and may be length 120, and a short axis of the elliptical cross section may be parallel to the vertical direction and may be a length 122. In order for a capacity of the jellyroll battery 112 to meet a demanded energy output of the load, dimensions of jellyroll battery 112 may be selected to provide enough electroactive material to reach the target capacity. To increase an amount of electroactive material, dimension of the jellyroll battery may be increased. Length 120 and length 122 may be limited by a desired form factor of prismatic battery housing 100. For this reason, axial length 118 of jellyroll battery 112 is increased to provide a large format jellyroll battery. In one example the axial length of the large format jellyroll battery may be greater than 300 mm. In further examples, the axial length of the large format jellyroll battery may be greater than 600 mm. The large format jellyroll battery may have a higher theoretical capacity than the conventional jellyroll battery. As one example, the large format jellyroll battery may have a theoretical capacity in a range from 110 Ah to 250 Ah and may store energy in a range from 350 Wh to 800 Wh. As a further example, the theoretical capacity of the large format jellyroll battery may be greater than or equal to 126 Ah and may store 407 Wh of energy.

Electrolyte demanded for operation of a lithium ion battery may be positioned within prismatic battery housing 100 along with jellyroll battery 112. Conventionally, electrolyte may permeate into jellyroll battery 112 via capillary action through axial ends of jellyroll battery 112 defined by the elliptical cross section of short axis 122 and long axis 120, but not through outer surface 124 due to the current collector being of non-permeable metal foil, thereby limiting an axial length of conventional jellyroll batteries. Jellyroll battery 112 may be a perforated jellyroll battery, the perforations providing additional channels of electrolyte permeation, resulting in a large format perforated jellyroll battery without bare spots not reached by electrolyte.

Limitations of conventional jellyroll batteries are described further with respect to the illustration of FIG. 2. FIG. 2 shows a conventional anode 202 and conventional cathode 204. Conventional anode 202 may include an anode current collector 206. An anode active material layer 208 may be positioned in face sharing contact a with a surface of anode current collector 206. Anode active material layer 208 may include anode active material capable of intercalating and deintercalating lithium ions. Anode active material layer 208 may be deposited onto the surface of anode current collector 206 leaving a portion of bare anode current collector at a longitudinal end of conventional anode 202. Conventional cathode 204 may include a cathode current collector 212. A cathode active material layer 210 may be positioned in face sharing contact with a surface of cathode current collector 212. Cathode active material layer 210 may include cathode active material layer including lithium ions and capable of intercalating and deintercalating the lithium ions. Cathode active material layer 210 may be deposited onto the surface of cathode current collector 212 leaving a portion of bare cathode current collector at a longitudinal end of conventional cathode 204. The bare portions of anode current collector 206 and of cathode current collector 212 may be used to electrically couple the jellyroll battery to terminals such as terminals 110 of FIG. 1.

A jellyroll battery, such as conventional jellyroll battery 214 may be formed by stacking conventional anode 202 and conventional cathode 204 with anode active material layer 208 facing cathode active material layer 210 with a separator layer positioned therebetween to form a stack. The separator may be an electrically insulating porous membrane capable of passing electrolyte and lithium ions. Conventional anode 202 and conventional cathode 204 may be positioned with the bare portions of the respective current collector positioned longitudinally opposite each other. The stack may be spirally wound in a lateral direction (e.g., parallel to the x axis) with respect to conventional anode 202 and conventional cathode 204 to form conventional jellyroll battery 214. A longitudinal length 218 of conventional anode 202 and conventional cathode 204 may be equivalent to the longitudinal length of the resulting jellyroll battery.

Longitudinal length 218 may be an axial length of conventional jellyroll battery 214. Although an outer surface of a jellyroll battery, such a conventional jellyroll battery 214 is formed of current collector, jellyroll batteries of FIGS. 2-5 are illustrated showing permeation of electrolyte 216 through the jellyroll battery. Electrolyte may permeate into conventional jellyroll battery 214 in an axial direction illustrated by arrows 224. Longitudinal length 218 of conventional jellyroll battery 214 may be short enough that electrolyte 216 permeates through an entire axial length of conventional jellyroll battery 214.

FIG. 2 also shows an example of a conventional large format jellyroll battery 226. Conventional large format jellyroll battery 226 may be formed by increasing length 218 to large format length 220. Large format length 220 may be greater than 300 mm. In some examples, large format length may be greater than 600 mm. Conventional large format jellyroll battery 226 may be limited to axial diffusion of electrolyte as shown by arrows 224. For this reason, conventional large format jellyroll battery 226 may include electrolyte 216 permeated into axial ends and an electrolyte free section 222 may be present in an axially center portion. Electrolyte free section 222 may not be able to transport ions and may not contribute to capacity of the battery. For this reason, a conventional large format jellyroll battery may not provide the demanded capacity for a single cell battery system such as battery system 101 of FIG. 1.

To prevent presence of an electrolyte free section, such as electrolyte free section 222, a perforated anode and cathode may be used to form a perforated jellyroll battery. The perforations may provide openings for electrolyte to penetrate radially through the wound jellyroll structure in addition to the conventional axial direction. In this way, efficient roll to roll manufacturing and directional venting provided by the jellyroll architecture may be maintained while providing an increase in capacity in the large format.

FIGS. 3-7 show examples of perforated anodes and cathodes and the resulting perforated jellyroll batteries. Perforated anodes and perforated cathodes may include similar components as conventional anodes and cathodes as described above with respect to FIG. 2. Such components are labeled the same and are not reintroduced. Anode perforations may be formed as longitudinally mirrored images (e.g., mirrored across the y-z plane) of cathode perforations with respect to the unwound perforated anode and cathode. In this way, when the perforated jellyroll battery is formed, anode perforations may radially and axially align with cathode perforations with respect to the wound perforated jellyroll battery, providing a continuous radial path for permeation of electrolyte.

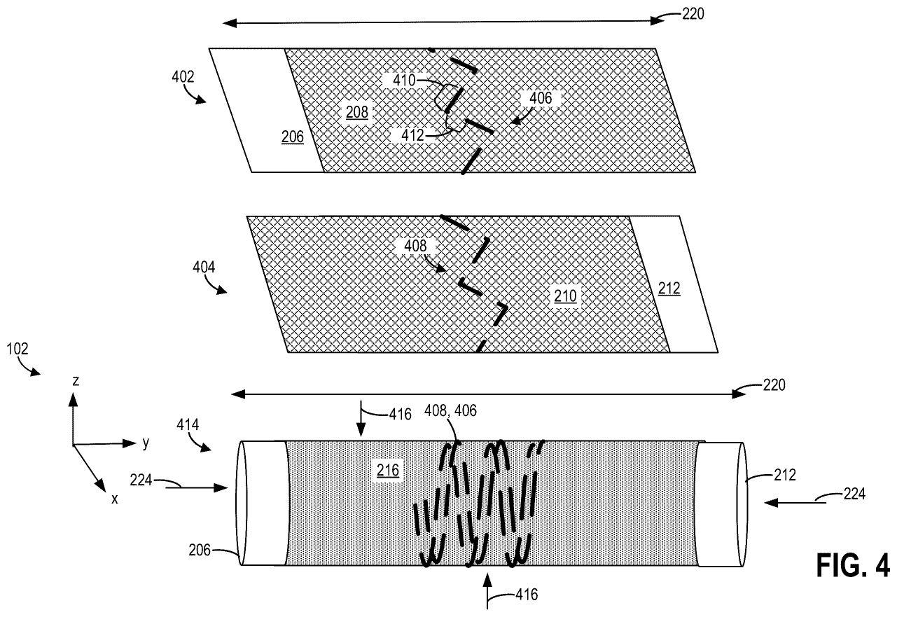

Turning now to FIG. 3 a first example of a perforated anode 302 and a perforated cathode 304 are shown. Perforated anode 302 and perforated cathode 304 may each be examples of large format anodes and cathodes and maybe the lateral length 220 as described above with respect to FIG. 2. Perforated anode 302 may include anode current collector 206 and anode active material layer 208. Perforated anode 302 may further include lateral anode perforations 306. Lateral anode perforations 306 may be formed as intermittent slits extending vertically with respect to the unwound perforated anode through in both the anode active material layer 208 and the anode current collector 206. Anode perforations, including lateral anode perforations and other anode perforations described in FIGS. 4-7, may extend linearly from a first longitudinal edge of perforated anode 302 to a second longitudinal edge of perforated anode 302, opposite the first longitudinal edge across the x-axis. The line of lateral anode perforations 306 may be parallel to lateral edges of perforated anode 302. Lateral anode perforations 306 may be a length 310 and may be spaced apart by a distance 312. In some examples length 310 may be in a range from 1 mm to 50 mm. A longitudinal width (e.g., along the y-axis) of lateral anode perforations 306 may be ≤1 mm. In some examples, distance 312 may be in a range from 1 mm to 50 mm. In one example lateral anode perforations 306 may be positioned longitudinally equidistant from lateral edges of anode active material layer 208. In alternate examples, lateral anode perforations 306 may include a plurality of lines of perforations, each extending linearly from the first longitudinal edge to the second longitudinal edge. In examples where lateral anode perforations include a plurality of lines, the plurality of lines may be longitudinally distributed evenly or unevenly across anode active material layer 208.

Perforated cathode 304 may include cathode current collector 212 and cathode active material layer 210. Perforated cathode 304 may further include lateral cathode perforations 308. Cathode perforations described herein, including lateral cathode perforations 308 and other cathode perforations described in FIGS. 4-7, may be a longitudinal mirror image across the y-z plane of the corresponding anode perforations. For example, lateral cathode perforations 308 may be a longitudinal mirror image across the y-z plane of lateral anode perforations 306 and may extend vertically through both the cathode active material layer 210 and cathode current collector 212. Dimensions (e.g., lateral length, longitudinal width, and spacing) of lateral cathode perforations 308 may be approximately (e.g., within +/−5%) the same as dimensions of anode perforations 306. An amount and longitudinal positioning of lateral cathode perforations 308 may be substantially the same as the amount and longitudinal positioning of lateral anode perforations 306. In this way, when the perforated anode 302 and perforated cathode 304 are stacked lateral cathode perforations 308 may be vertically positioned in line with corresponding lateral anode perforations.

Stacking and rolling perforated anode 302 and perforated cathode 304 with a separator as described above may result in a perforated jellyroll battery 314. Lateral anode perforations 306 and lateral cathode perforations 308 may be axially and radially aligned. When perforated jellyroll battery 314 is placed in a housing with electrolyte, electrolyte may radially permeate into perforated jellyroll battery 314 through the anode and cathode perforations in the direction indicated by arrows 316 in addition to axially. For this reason, even though perforated jellyroll battery 314 may be a large format jellyroll battery having a length 220 greater than or equal to 300 mm, electrolyte 216 may be present throughout perforated jellyroll battery 314 without any anode or cathode active material layers with electrolyte free sections. In alternate examples, length 220 may be greater than or equal to 600 mm.

Turning now to FIG. 4, a second example of a perforated anode 402 and a second example of a perforated cathode 404 are shown. The second examples of perforated anode 402 and perforated cathode 404 may include diagonal anode perforations 406 and diagonal cathode perforations 408 respectively. Diagonal anode perforations 406 may include slits formed at alternating angles with respect to the longitudinal edge of the anode to form a zig-zag pattern. Diagonal anode perforations 406 may extend laterally from a first longitudinal edge of anode active material layer 208 to the second longitudinal edge of anode active material layer 208. Diagonal anode perforations 406 many include slits having length 410 and spaced apart by a distance 412. In one examples, length 410 may be in a range from 1 mm to 50 mm. A longitudinal width (e.g., along the y-axis) of diagonal anode perforations 406 may ≤1 mm. Distance 412 may be in a range from 1 m to 50 mm. In some examples, diagonal anode perforations 406 may include a single zig-zag of perforations starting at a longitudinal middle of anode active material layer 208. In alternate examples, diagonal anode perforations 406 may include a plurality of zig-zags extending between the longitudinal edges of the anode active material layer 208. The plurality of zig-zags may be evenly or unevenly longitudinally spaced across anode active material layer 208.

Second example of perforated cathode 404 may include diagonal cathode perforations 408. Diagonal cathode perforations 408 may be a longitudinal mirror image across the y-z plane of diagonal anode perforations 406. In this way, diagonal anode perforations 406 and diagonal cathode perforations 408 may laterally and longitudinally align when perforated anode 402 is stacked on perforated cathode 404 with anode active material layer 208 facing cathode active material layer 210 with a separator positioned between.

Second perforated anode 402 and second perforated cathode 404 may be used to form a second perforated jellyroll battery 414. When second perforated jellyroll battery 414 is placed within a housing including electrolyte 216, electrolyte 216 may penetrate into second perforated jellyroll battery both axially as shown by arrow 224 and radially as shown by arrows 416. Radial penetration of electrolyte may be through diagonal anode perforations 406 and diagonal cathode perforations 408. In this way, electrolyte 216 may permeate throughout active material layers of second perforated jellyroll battery 414, even though second perforated jellyroll battery 414 may be an example of a large format battery having an axial length of greater than or equal to 300 mm or greater than or equal to 600 mm.

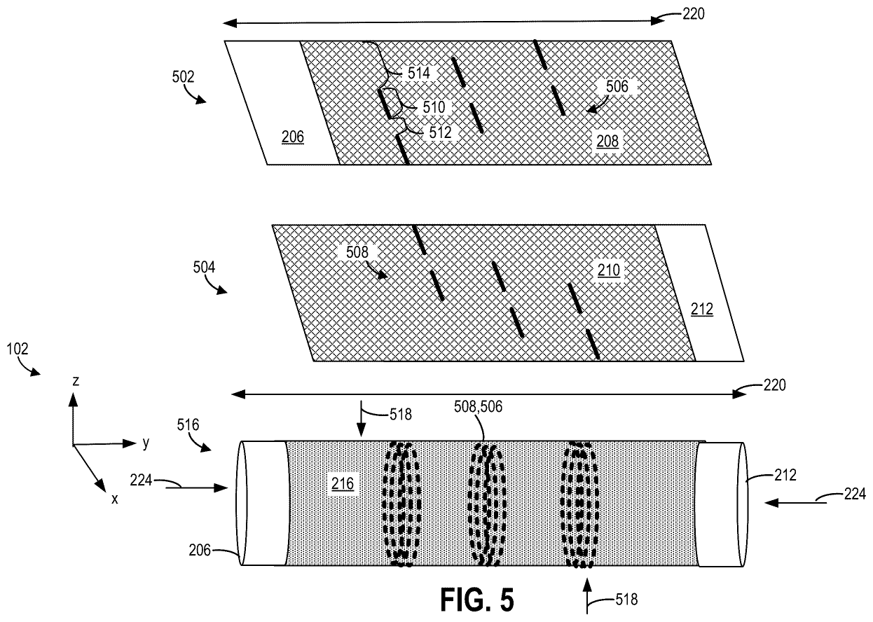

Turning now to FIG. 5 a third example of a perforated anode 502 and a third example of a perforated cathode 504 are shown. The third examples of perforated anode 502 and perforated cathode 504 may include variably spaced anode perforations 506 and variably spaced cathode perforations 508 respectively. Variably spaced anode perforations 506 may include a plurality of laterally extending perforations, each laterally extending perforation including perforations of a length 510 intermittently spaced apart by a first distance 512 and by a second distance 514. In some examples, length 510 may be in a range from 1 mm to 50 mm. A longitudinal width (e.g., along the y-axis) of variably spaced anode perforations may be ≤1 mm. In one example first distance 512 and second distance 514 may each be within a range of 1 mm to 50 mm. In some examples, first distance 512 may be shorter than second distance 514. Neighboring laterally extending perforations may be offset from each other in the lateral direction. Each of the laterally extending protrusions may be substantially the same as a neighboring laterally extending protrusion. In this way, first distances and second distances are staggered in the longitudinal direction and not fully overlapping. Placing perforations in this way help mitigate localized heating and increase in cell resistance which may occur due to interruptions in current flow through the current collectors to the terminals of the battery system. In one example, the plurality of laterally extending perforations may include three laterally extending perforations, although other numbers of laterally extending perforations may be used. The plurality of laterally extending protrusions may be evenly longitudinally spaced across anode active material layer 208. In alternate examples, longitudinal spacing between the plurality of laterally extending may not be equal.

Third perforated cathode 504 may include variably spaced cathode perforations 508. Dimensions of variably spaced cathode perforations 508 may be the substantially the same as variably spaced anode perforations 506 mirrored across the y-axis. In this way, when third perforated cathode 504 and third perforated anode 502 are stacked with anode active material layer 208 facing cathode active material layer 210 variably spaced anode perforations and variably spaced cathode perforations may be aligned in the lateral and longitudinal direction. In this way, radial pathways for electrolyte are formed when spirally wound to form third perforated jellyroll battery 516.

Third perforated anode 502 and third perforated cathode 504 may be used to form a third perforated jellyroll battery 516. When third perforated jellyroll battery 516 is placed within a housing including electrolyte 216, electrolyte 216 may penetrate into second perforated jellyroll battery both axially as shown by arrow 224 and radially as shown by arrows 518. Radial penetrations of electrolyte may be through variably spaced anode perforations 506 and variably spaced cathode perforations 508. In this way, electrolyte 216 may permeate throughout active material layers of third perforated jellyroll battery 516, even though third perforated jellyroll battery 516 may be an example of a large format battery having an axial length of greater than or equal to 300 mm. In some examples the axial length of the large format battery may be greater than or equal to 600 mm. Lateral offsets of the variably spaced anode perforations 506 and variably spaced cathode perforations 508 may help mitigate localized temperature increases and increase in cell resistivity due to localized interruptions in axial current flow during operations of the battery system.

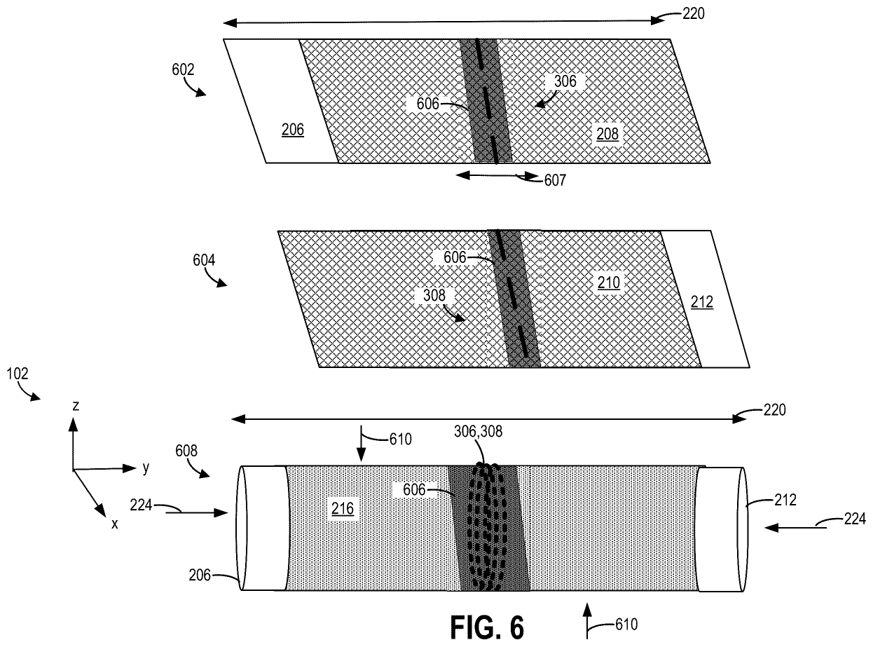

Turning now to FIG. 6 an example of a fourth perforated anode 602 and fourth perforated cathode 604 are shown. Fourth perforated anode 602 and fourth perforated cathode 604 may include a coating 606 covering both the perforations of the fourth perforated anode 602 and fourth perforated cathode 604. In some examples the coated perorations may be lateral anode perforations 306 and lateral cathode perforations 308. In alternate examples, other patterns of perforations, such as those shown in FIGS. 3-5 may be covered by coating 606. The coating may be coated onto one or more of anode active material layer 208 and cathode active material layer 210. Additionally or alternatively, the coating may be coated onto perforations and onto anode current collector 206 and/or cathode current collector 212. Coating 606 may cover and penetrate into slits of lateral anode perforations 306 and lateral cathode perforations 308. Coating 606 may cover a continuous rectangular area in which anode perforations of cathode perforations are roughly in the center. In one example, a longitudinal width 607 of coating 606 may be less than a longitudinal width of anode active material layer 208. In alternate examples the longitudinal width 607 may be equivalent to the longitudinal width anode active material layer 208 and less than length 220.

Coating 606 may be electrolyte permeable and electrically conductive. In some examples, coating 606 may be formed of one or more of an electroactive material, a conducting agent, and a binder. In some examples coating 606 may be formed of the electroactive material, the conducting agent and the binder. The electroactive material may include one or more of a metal oxide and iron phosphate. In some examples the metal oxide may be a lithium metal oxide (e.g., lithium nickel manganese cobalt oxide) and the iron phosphate may be a lithium iron phosphate. The conducting agent may be, for example, one or more of carbon black, carbon nanotubes, and polyvinylidene fluoride (PVDF). In one example binders forming coating 606 may include one or more of carboxymethylcellulose (CMC) binders and styrene-butadiene rubber (SBR) binders.

Fourth perforated anode 602 and fourth perforated cathode 604 may be assembled into a fourth perforated jellyroll battery 608. When fourth perforated jellyroll battery 608 is placed within a housing including electrolyte 216, electrolyte 216 may penetrate into fourth perforated jellyroll battery 608 both axially as shown by arrow 224 and radially as shown by arrows 610. Coating 606 may be permeable to electrolyte may not prevent radial permeation of electrolyte through perforations. In this way length 220 of fourth perforated jellyroll battery 608 may greater than or equal to 300 mm and may be greater than or equal to 600 mm.

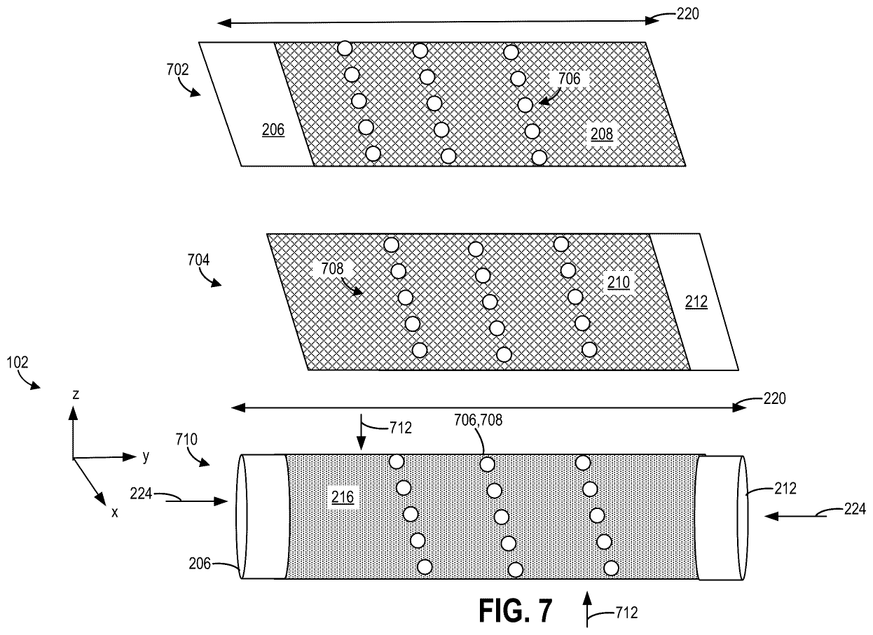

Turning now to FIG. 7, an example of a fifth perforated anode 702 and a fifth perforated cathode 704 are shown. Fifth perforated anode 702 and fifth perforated cathode 704 may include anode die cut perforations 706 and cathode die cut perforations 708 respectively. Die cut perforations, such as anode die cut perforations 706 and cathode die cut perforations 708 may be formed in a shape having a length and a substantial width as opposed to perforations described in FIGS. 3-5 formed as slits having a length. In one example die cut perforations may be circular having a diameter in a range of 1 mm to 10 mm. In one example die cut perforations may include a plurality of laterally extending columns of die cut perforations. In alternate examples, die cut perforations may be positioned in other patterns, such as patterns of the perforations shown in FIGS. 3-5. In some examples, fifth perforated anode 702 and/or fifth perforated cathode 704 may include a coating, such as coating 606 described above with respect to FIG. 6. Cathode die cut perforations 708 may be positioned to be mirror images across the y-z plane of anode die cut perforations 706.

Fifth perforated anode 702 and fifth perforated cathode 704 may be assembled into a fifth perforated jellyroll battery 710. When fifth perforated jellyroll battery 710 is placed within a housing including electrolyte 216, electrolyte 216 may penetrate into fifth perforated jellyroll battery 710 both axially as shown by arrow 224 and radially as shown by arrows 712. Anode die cut perforations 706 and cathode die cut perforations 708 may align radially and axially in fifth perforated jellyroll battery 710 to facilitate radial penetration of electrolyte throughout fifth perforated jellyroll battery 710. In this way length 220 of fifth perforated jellyroll battery 710 may be greater than or equal to 300 mm and may be greater than or equal to 600 mm.

Turning now to FIG. 8, an example of a method 800 for forming a battery system including a perforated jellyroll battery is shown. The perforated jellyroll battery may be one or more of the first through fifth jellyroll batteries described above with respect to FIGS. 3-7. At 802, method 800 includes coating anode and cathode active material onto respective current collectors in a dry coating and/or wet (e.g., slurry) coating process. Herein, electrode may refer to anode and/or cathode. In a dry coating process, coating may include first blending conductive particles (e.g., activated carbon), electroactive particles and binder together, applying shear force and the feeding the blend onto a current collector, calendering the electrode (e.g., anode and cathode) and the bonding the material to the current collector. In a wet coating process, coating may include blending or mixing together electroactive materials, conductive particles, binder, and solvent together to form a slurry, coating the slurry onto the current collector, calendering the coating. In one example, slitting and coating may be done in a roll to roll process.

At 804, method 800 optionally includes slitting the anode and cathode. Slitting may be performed when cathode and/or anode active material are coated with a wet coating process. Slitting may be done in a roll to roll process. Slitting may apply a cut to a lateral center of the electrode to split the electrode in half, resulting in forming two rolls of electrode from a single roll of electrode.

At 806, method 800 includes perforating the anode and cathode. In one example, perforating may be performed as part of a roll to roll manufacturing process. For example, perforating may include passing the electrode through a knife roll. The knife roll may cut slits through the anode and/or cathode. The slits may penetrate through the electrode active material layer and through the current collector. Slits cut by the knife roll may be a length and spaced apart based on a pattern of knives on the knife roll. In an alternate example, perforating may include passing the electrode through a die cutter. The die cutter may cut shapes having a length and width and spaced apart by a distance based on a pattern of the punch on the die cutter. In one example the die cutter may cut circular holes in the electrodes.

At 807, method 800 includes optionally applying a conductive coating to the anode perforations and/or cathode perforations. The conductive coating may be the coating as described above with respect to FIG. 6 and may be electrically conductive and permeable to electrolyte. In one example, the conductive coating may include one or more of an electroactive material, conducting agent, and binder.

Turning briefly to FIG. 9, an example of slitting and perforating in a roll to roll process is shown. A first roll 902 may include coated and un-slit electrode 904. Coated and un-slit electrode 904 may be unspooled from first roll 902 and fed through slitter 906. Slitter 906 may be a blade configured to slit coated and un-slit electrode 904 through a lateral center axis to form two coated and slit electrodes 908. Each of the coated and slit electrodes 908 may be passed through roll to roll perforators 910. Roll to roll perforators 910 may each include a top roller 910a and bottom roller 910b vertically stacked. Coat and slit electrodes 908 may be passed between top roller 910a and bottom roller 910b. In one example, roll to roll perforators 910 may be knife rollers and top roller 910a may include knives configured to cut slits into the coated and slit electrodes. In alternate examples the roll to roll perforators 910 may be die cutters and top roller 910a may include die punches configures to cut circular or other shaped holes into coated and slit electrodes 908. After passing through roll to roll perforators, the punctured electrodes 912 may be rolled onto second rolls 914.

Returning now to FIG. 8, at 808, method 800 includes stacking the perforated anode and perforated cathode and laterally and longitudinally aligning anode perforations with cathode perforations. Stacking may also include positioning a separator between the perforated anode and the perforated cathode. In the stack the anode active material layer and cathode active material layer may be facing each other across the separator. Each anode perforation may align laterally and longitudinally with a cathode perforation due to the cathode perforations being longitudinal mirror images of the anode perforations.

Turning briefly to FIG. 10, it shows a cross sectional view of a perforated anode 1002 stacked on the perforated cathode 1004 before winding. Perforated anode 1002 and perforated cathode 1004 may be examples of any one of the first through fifth examples shown in FIGS. 3-7. Perforated anode may include anode active material layer 1006, anode current collector 1008 and anode perforations 1010. Perforated cathode may include 1004 may include cathode active material layer 1012, cathode current collector 1014, and cathode perforations 1016. Perforated anode 1002 and perforated 1004 may be separated by separator 1018 positioned between perforated anode 1002 and perforated cathode 10004. Cathode perforations 1016 and anode perforations 1010 may be aligned to provide an effective radial pathway for electrolyte through the jellyroll battery when wound.

Returning now to FIG. 8, at 810, method 800 includes winding the stacked perforated anode and perforated cathode to form a perforated jellyroll battery. Winding may include winding along the lateral axis of the stacked perforated electrodes such that the extending current collectors are positioned at opposite axial ends for the perforated jellyroll battery as shown in FIGS. 3-7.

At 812, method 800 includes encasing the perforated jellyroll battery in prismatic battery housing along with electrolyte. The electrolyte may penetrate into the jellyroll battery axially as well as radially. Radial penetration of electrolyte may be through the aligned perforations of the cathode and anode. In this way electrolyte may permeate throughout the perforated jellyroll battery and may not leave any spots of electrode active material not in contact with electrolyte.

In this way, a perforated large format jellyroll battery may be formed with an increased available power and cycle lifetime compared to a large format jellyroll battery without perforations which may include bare spots of electrode active material not in contact with electrolyte. The perforated large format jellyroll battery may be used as a single battery cell in a battery system thereby simplifying the battery system and eliminating the demand for complicated balancing of charging and discharging between cells. Further the large format jellyroll battery may be manufactured faster than a stacked electrode battery architecture while still achieving the desired power output of the single cell. Dimensions and relative positioning of the perforations may be selected to provide sufficient permeation of electrolyte without causing a significant increase in the cell resistance, localized heating in the perforated areas, and temperature gradients across the jellyroll battery.

The technical effect of perforating the anode and cathode as described in method 800 is to form a perforated jellyroll battery. The perforated jellyroll battery has the advantages described above with respect to increase electrolyte penetration over a conventional jellyroll battery without perforations. The increased electrolyte penetration allows for a large format jellyroll battery without electrolyte free areas of anode and cathode active material. Further, the positioning and optionally coating of the perforations may help to mitigate the localized heating and increases in overall cell resistivity caused by interruption of current flow through the current collector.

As described herein, various issues with jellyroll batteries, rather than double layer capacitors, may be addressed. As one example, a battery may have both an anode layer on an anode current collector and a cathode layer on a cathode current collector which are rolled together in the jellyroll battery architecture, therefore expecting different but complementary scoring patterns which are not considered for a double layer capacitor which includes only a single double coated current collector. Further, lack of consideration of localized heating and interruption of current flow as a result of puncturing the current collector may occur. As explained herein, these and other issues are at least partially addressed by the approaches described, including the following:

As one embodiment, the disclosure also provides support for a perforated jellyroll battery comprising: a perforated anode including an anode active material layer, an anode current collector and anode perforations passing vertically with respect to an axis of an unwound perforated anode through the anode active material layer and anode current collector, a perforated cathode including a cathode active material layer, a cathode current collector and cathode perforations passing vertically with respect to an axis of an unwound perforated cathode through the cathode active material layer and cathode current collector, and a separator positioned between the perforated anode and the perforated cathode, and wherein, with respect to and axis of the perforated jellyroll battery, the anode perforations are radially and axially aligned with the cathode perforations. In a first example of the system, the anode perforations and cathode perforations each include a plurality of perforations extending laterally with respect to the unwound perforated anode and cathode. In a second example of the system, optionally including the first example, spacing of the plurality of perforations are offset from each other laterally with respect to the unwound perforated anode and cathode. In a third example of the system, optionally including one or both of the first and second examples, the perforated jellyroll battery is a large format jellyroll battery and an axial length of the perforated jellyroll battery is greater than or equal to 300 mm. In a fourth example of the system, optionally including one or more or each of the first through third examples, the anode perforations and cathode perforations are coated. In a fifth example of the system, optionally including one or more or each of the first through fourth examples, the anode perforations and cathode perforations are circular. In a sixth example of the system, optionally including one or more or each of the first through fifth examples, the cathode perforations are longitudinal mirror images of the anode perforations with respect to the unwound perforated anode and cathode.

The disclosure also provides support for a method for forming a perforated jellyroll battery, comprising: perforating an anode in a roll to roll process, the anode including an anode active material layer deposited on an anode current collector, wherein perforating penetrates both the anode active material layer and the anode current collector to form anode perforations, perforating a cathode in the roll to roll process, the cathode including a cathode active material layer deposited on a cathode current collector, wherein perforating the cathode penetrates both the cathode active material layer and the cathode current collector to form cathode perforations, stacking the perforated anode and perforated cathode, wherein stacking includes laterally and longitudinally aligning the anode perforations and cathode perforations with respect to the perforated anode and cathode, and winding the stacked perforated anode and cathode to form the perforated jellyroll battery. In a first example of the method, the method further comprises: encasing the perforated jellyroll battery in a prismatic battery housing and wherein the prismatic battery housing includes electrolyte. In a second example of the method, optionally including the first example, electrolyte permeates the perforated jellyroll battery in an axial direction and in a radial direction with respect to the perforated jellyroll battery through the cathode perforations and the anode perforations. In a third example of the method, optionally including one or both of the first and second examples, the method further comprises: applying a coating to the anode perforations and the cathode perforations before stacking, wherein the coating is wherein the coating is formed of one or more of an electroactive material, a conducting agent, and a binder. In a fourth example of the method, optionally including one or more or each of the first through third examples, perforating the anode and/or perforating the cathode includes passing the anode and/or cathode through a knife roll. In a fifth example of the method, optionally including one or more or each of the first through fourth examples, the method further comprises: slitting the anode and/or cathode before perforating the anode and/or cathode. In a sixth example of the method, optionally including one or more or each of the first through fifth examples, perforating the anode and/or perforating the cathode includes passing the anode and/or cathode through a die cutter.

The disclosure also provides support for a battery system, comprising: a prismatic battery housing, a perforated jellyroll battery positioned within the prismatic battery housing, wherein the perforated jellyroll battery includes a perforated anode including an anode current collector, anode active material layer and anode perforations extending through the anode current collector and anode active material layer, and a perforated cathode including a cathode current collector, cathode active material layer, and cathode perforations extending through the cathode current collector and cathode material layer, and wherein the perforated anode includes anode perforations radially and axially aligned with cathode perforations of the perforated cathode with respect to the perforated jellyroll battery, and electrolyte, wherein electrolyte is distributed throughout the anode active material layer and cathode material layer. In a first example of the system, an axial length of the perforated jellyroll battery is greater than or equal to 300 mm. In a second example of the system, optionally including the first example, an axial length of the perforated jellyroll battery is greater than or equal to 600 mm. In a third example of the system, optionally including one or both of the first and second examples, the prismatic battery housing includes terminals positioned on a smallest face of the prismatic battery housing. In a fourth example of the system, optionally including one or more or each of the first through third examples, the perforated anode and perforated cathode further include a permeable and electrically conductive coating. In a fifth example of the system, optionally including one or more or each of the first through fourth examples, the anode perforations and the cathode perforations are a lateral length in a range of 1 mm to 50 mm and spaced apart by a distance in range of 1 mm to 50 mm. As used herein, the term “approximately” is construed to mean plus or minus five percent of the range unless otherwise specified.

FIGS. 1-7 and 9-10 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A perforated jellyroll battery, comprising:
a perforated anode including an anode active material layer, an anode current collector and anode perforations passing vertically with respect to an axis of an unwound perforated anode through the anode active material layer and anode current collector;
a perforated cathode including a cathode active material layer, a cathode current collector and cathode perforations passing vertically with respect to an axis of an unwound perforated cathode through the cathode active material layer and cathode current collector; and
a separator positioned between the perforated anode and the perforated cathode, and wherein, with respect to an axis of the perforated jellyroll battery, the anode perforations are radially and axially aligned with the cathode perforations.

2. The perforated jellyroll battery of claim 1, wherein the anode perforations and cathode perforations each include a plurality of perforations extending laterally with respect to the unwound perforated anode and cathode.

3. The perforated jellyroll battery of claim 2, wherein spacing of the plurality of perforations are offset from each other laterally with respect to the unwound perforated anode and cathode.

4. The perforated jellyroll battery of claim 1, wherein the perforated jellyroll battery is a large format jellyroll battery and an axial length of the perforated jellyroll battery is greater than or equal to 300 mm.

5. The perforated jellyroll battery of claim 1, wherein the anode perforations and cathode perforations are coated.

6. The perforated jellyroll battery of claim 1, wherein the anode perforations and cathode perforations are circular.

7. The perforated jellyroll battery of claim 1, wherein the cathode perforations are longitudinal mirror images of the anode perforations with respect to the unwound perforated anode and cathode.

8. A method for forming a perforated jellyroll battery, comprising:
perforating an anode in a roll to roll process, the anode including an anode active material layer deposited on an anode current collector, wherein perforating penetrates both the anode active material layer and the anode current collector to form anode perforations;
perforating a cathode in the roll to roll process, the cathode including a cathode active material layer deposited on a cathode current collector, wherein perforating the cathode penetrates both the cathode active material layer and the cathode current collector to form cathode perforations;
stacking the perforated anode and perforated cathode, wherein stacking includes laterally and longitudinally aligning the anode perforations and cathode perforations with respect to the perforated anode and cathode; and
winding the stacked perforated anode and cathode to form the perforated jellyroll battery.

9. The method of claim 8, further comprising encasing the perforated jellyroll battery in a prismatic battery housing and wherein the prismatic battery housing includes electrolyte.

10. The method of claim 9, wherein electrolyte permeates the perforated jellyroll battery in an axial direction and in a radial direction with respect to the perforated jellyroll battery through the cathode perforations and the anode perforations.

11. The method of claim 8, further comprising applying a coating to the anode perforations and the cathode perforations before stacking, wherein the coating is formed of one or more of an electroactive material, a conducting agent, and a binder.

12. The method of claim 8, wherein perforating the anode and/or perforating the cathode includes passing the anode and/or cathode through a knife roll.

13. The method of claim 8, further comprising slitting the anode and/or cathode before perforating the anode and/or cathode.

14. The method of claim 8, wherein perforating the anode and/or perforating the cathode includes passing the anode and/or cathode through a die cutter.

15. A battery system, comprising:
a prismatic battery housing;
a perforated jellyroll battery positioned within the prismatic battery housing, wherein the perforated jellyroll battery includes a perforated anode including an anode current collector, anode active material layer and anode perforations extending through the anode current collector and anode active material layer, and a perforated cathode including a cathode current collector, cathode active material layer, and cathode perforations extending through the cathode current collector and cathode material layer, and wherein the perforated anode includes anode perforations radially and axially aligned with cathode perforations of the perforated cathode with respect to the perforated jellyroll battery; and
electrolyte, wherein electrolyte is distributed throughout the anode active material layer and cathode material layer.

16. The battery system of claim 15, wherein an axial length of the perforated jellyroll battery is greater than or equal to 300 mm.

17. The battery system of claim 15, wherein an axial length of the perforated jellyroll battery is greater than or equal to 600 mm.

18. The battery system of claim 15, wherein the prismatic battery housing includes terminals positioned on a smallest face of the prismatic battery housing.

19. The battery system of claim 15, wherein the perforated anode and perforated cathode further include an electrolyte permeable and electrically conductive coating.

20. The battery system of claim 15, wherein the anode perforations and the cathode perforations are a lateral length in a range of 1 mm to 50 mm and spaced apart by a distance in range of 1 mm to 50 mm.
